(19) United States
(12) Patent Application Publication
(10) Pub. No.: US 2010/0090989 A1
(43) Pub. Date: Apr. 15, 2010

(54) PORTABLE ELECTRONIC DEVICE

(75) Inventor: ZHOU-QUAN ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/536,305

(22) Filed: Aug. 5, 2009

(30) Foreign Application Priority Data
Oct. 10, 2008 (CN) 200810304877.4

(51) Int. Cl. G09G 5/00

(52) U.S. Cl. 345/184

(57) ABSTRACT

A portable electronic device includes a cover assembly and a rotating mechanism. The rotating mechanism is mounted to the cover assembly. The rotating mechanism includes a rotating assembly and a driving assembly. The rotating assembly includes a driving wheel and a driven wheel connected to the driving wheel. The driving wheel is connected to the rotating assembly. The driving assembly drives the driven wheel to rotate via the driving wheel, thus giving a user a rotating prompt.

### BACKGROUND

1. Technical Field

The present disclosure relates to portable electronic devices and, particularly, to a portable electronic device with a special prompt of incoming calls or short messages.

2. Description of Related Art

With the development of technology, portable electronic devices have become widely used. To alert users of incoming calls or short message, portable electronic devices are equipped with prompts, e.g. audios, vibration, and flashing lights.

However, audios may disturb others under certain conditions such as in a meeting. Vibration may cause unintentional damages to the portable electronic devices such as falling off a desk. A dim flashing light may not be easily sensed by a user.

Therefore, there is room for improvement within the art.

### BRIEF DESCRIPTION OF THE DRAWINGS

Many aspects of a portable electronic device can be better understood with reference to the following drawings. These drawings are not necessarily drawn to scale, the emphasis instead being placed upon clearly illustrating the principles of the present portable electronic device. Moreover, in the drawings like reference numerals designate corresponding sections throughout the several views.

FIG. 1 is an isometric, exploded view of a portable electronic device, in accordance with an exemplary embodiment.

FIG. 2 is similar to FIG. 2, but viewed from another aspect.

FIG. 3 is an isometric, exploded, enlarged view of a rotating mechanism of the portable electronic device shown in FIG. 1.

FIG. 4 is similar to FIG. 3, but viewed from another aspect.

FIG. 5 is an assembled view of the rotating mechanism shown in FIG. 3.

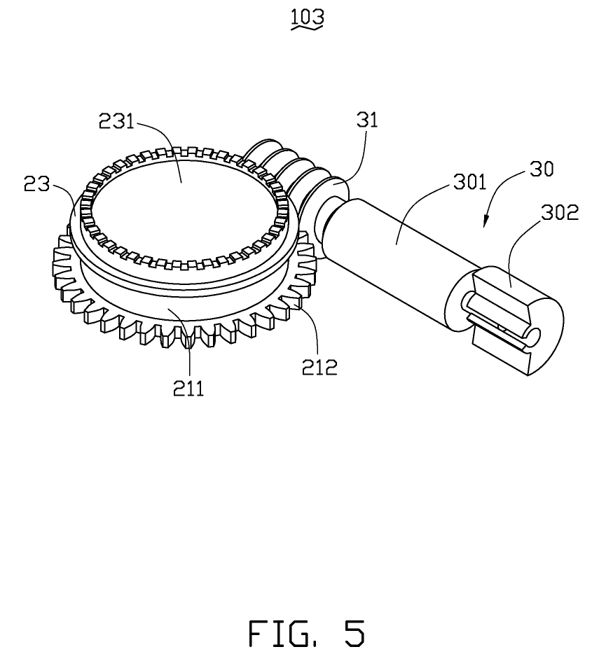

FIG. 6 is an assembled view of the portable electronic device shown in FIG. 1.

### DETAILED DESCRIPTION

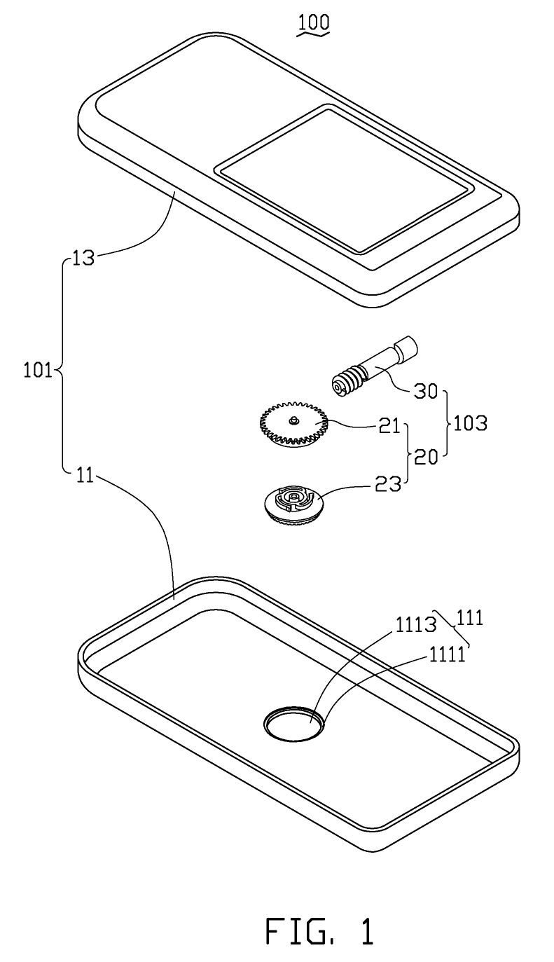

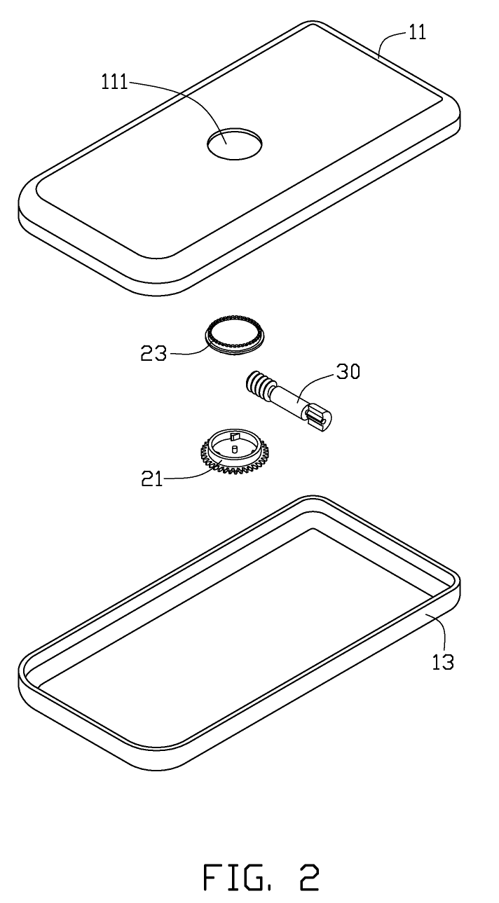

FIGS. 1 and 2 show an exemplary portable electronic device 100. The portable electronic device 100 includes a cover assembly 101 and a rotating mechanism 103. The rotating mechanism 103 is mounted to the cover assembly 101.

The cover assembly 101 includes a first cover 11 and a second cover 12 combined with the first cover 11. The first cover 11 includes a mounting portion 111 defined thereon. In this embodiment, the mounting portion 111 is a shoulder hole includes a first bottom wall 1111 and a through hole 1113 through the first cover 11.

The rotating mechanism 103 is sandwiched between the first cover 11 and the second cover 13. The rotating mechanism 103 includes a rotating assembly 20 and a driving assembly 30.

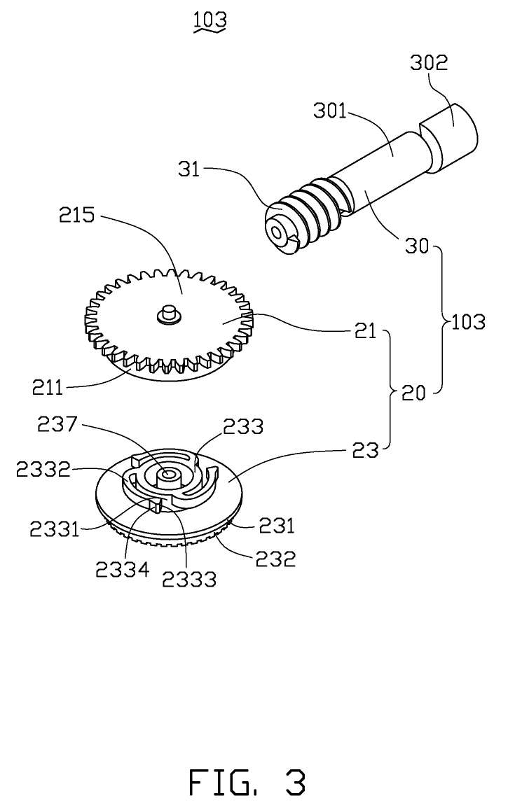

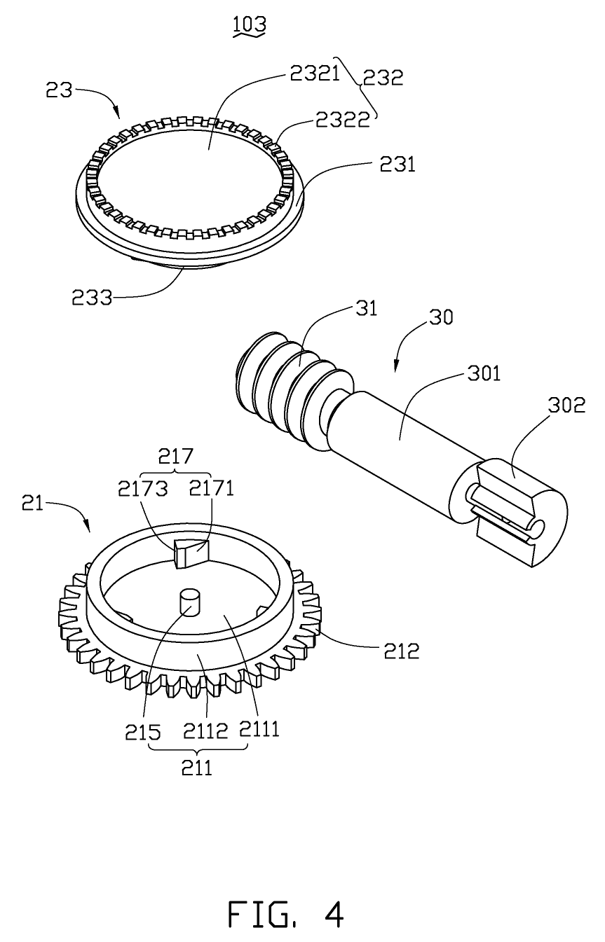

Referring to FIGS. 3 and 4, the rotating assembly 20 includes a driving wheel 21 and a driven wheel 23 driven by the driving wheel 21. The driving wheel 21 includes a cam portion 211 disposed at one end thereof and a gear portion 212 disposed at the other end thereof. The cam portion 211 is a hollow column with a second bottom wall 2111 and a peripheral wall 2112. The bottom wall 2111 includes a pivoting pole 215 protruding therefrom at a center. The peripheral wall 2112 includes three stopping blocks 217 spacedly disposed on an interior surface of the peripheral wall 2112. Each stopping block 217 is a cuneiform block including a sliding surface 2171 and a stopping surface 2173 opposite to the sliding surface 2171. The gear portion 212 cooperates with the driving assembly 30.

The driven wheel 23 includes a base 231, a support portion 232, and a connecting portion 233. The support portion 232 and the connecting portion 233 protrude from opposite surfaces of the base 231, respectively. The support portion 232 is a generally annular resisting wall with a support wall 2321. The support wall 2321 defines a plurality of grooves 2322 to enlarge the friction force when the support portion 232 is located on a surface, e.g., a desk. The support portion 232 protrudes from a peripheral edge of the base 231, and exposing out of the mounting portion 111. The connecting portion 233 is a hollow column, and includes a peripheral wall 2331 and three resisting arms 2332. The resisting arms 2332 protrude from and extend along the peripheral wall 2331, corresponding to the stopping blocks 217. One end of each resisting arm 2332 is fastened to the peripheral wall 2331. The other end of the resisting arm 2332 is a free end with a resisting surface 2333 and a slope surface 2334. Each resisting surface 2333 abuts against the stopping surface 2173 of a corresponding stopping block 217. Each sliding surface 2171 faces a corresponding slope surface 2334. The base 231 includes a hollow pivoting column 237 protruding therefrom at a center. The pivoting column 237 is received in the connecting portion 233. The pivoting column 237 receives the pivoting pole 215 therein, so that the driving wheel 21 and the driven wheel 23 rotate about a same axis, i.e., the pivoting column 237.

The driving assembly 30 includes a pivoting shaft 301 and a power generating device 302. The pivoting shaft 301 includes a worm gear 31 axially disposed at one end thereof. The pivoting shaft 301 is connected to the power generating device 302 at the other end, thus the power generating device 302 drives the pivoting shaft 301 to rotate clockwise or counter clockwise. If the pivoting shaft 301 rotates clockwise, each resisting surface 2333 resists one corresponding stopping surface 2173 and drives the driven wheel 23 rotate. If the pivoting shaft 301 rotates counter clockwise, each sliding surface 2171 of the driving wheel 21 slides along one corresponding slope surface 2334, thus the driven wheel 23 stays put. The power generating device 302 is an electric motor in the exemplary embodiment.

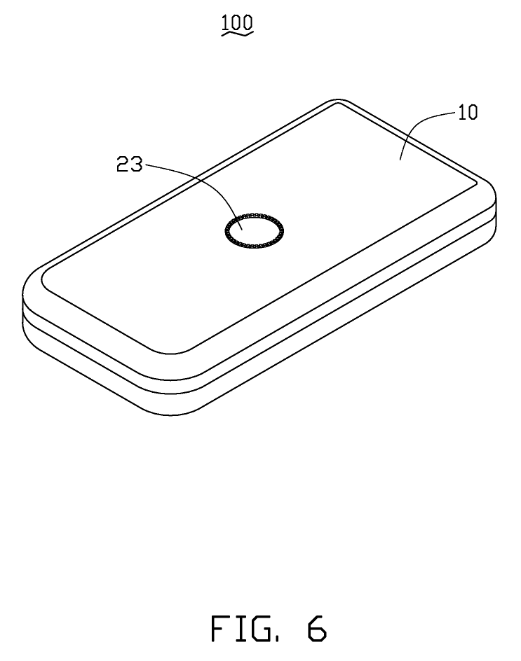

Referring to FIG. 2, in assembly, the driven wheel 23 is mounted within the mounting portion 111, with the support portion 232 slightly exposing out of the through hole 1113, and the base resisting the first bottom wall 1111. The driving wheel 21 and the driving assembly 30 are mounted between the first cover 11 and the second cover 13. The pivoting pole 215 is received in the pivoting column 237. The resisting surface 2333 abuts against the stopping surface 2173 of the stopping block 217. The sliding surface 2171 faces the slope surface 2334. The worm gear 31 engages with the gear portion 212. Thus, the portable electronic device 100 has been assembled (see FIG. 6).

In use, the power generating device 302 is triggered to rotate the pivoting shaft 301 clockwise. The worm gear 31 rotates clockwise with the pivoting shaft 301. Meanwhile, the worm gear 31 drives the gear portion 212 to rotate the driven wheel 23. Thus, when the support wall 2321 is securely placed on a surface, e.g., desk, the portable electronic device 100 can be rotated about the pivoting pole 215. Thus, the portable electronic device 100 can efficiently remind a user of incoming calls or short message by rotating itself without noise.

In an alternative embodiment, the portable electronic device 100 can be provided with typical prompts, e.g. audios, vibration, and flashing lights besides the present rotating prompt. Thus, the portable electronic device 100 further includes a control module (not shown), used to facilitate a user selecting a preferred prompt. If the portable electronic device 100 isn't set in the present rotating prompt, the power generating device 302 will be triggered to rotate the pivoting shaft 301 counter clockwise, thus, the sliding surface 2171 slides along the slope surface 2334, thus the driven wheel 23 stays put.

In a third alternative embodiment, the driven wheel 23 can includes a plurality of flashes (not shown) disposed thereon, when the driven wheel 23 rotates, the flashes are triggered together to alert a user.

In a fourth alternative embodiment, the number of stopping blocks 217 is not limit to three, but can be one, two or other numbers, the number of connecting portion 233 alters as that of the stopping blocks 217.

In a fifth alternative embodiment, the stopping blocks 217 can be disposed on the driven wheel 23, correspondingly, the connecting portion 233 can be disposed on the driving wheel 21.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A portable electronic device comprising:
a cover assembly; and
a rotating mechanism mounted to the cover assembly, the rotating mechanism including a rotating assembly and a driving assembly, the rotating assembly including a driving wheel and a driven wheel connected to the driving wheel, the driving wheel being connected to the rotating assembly, the driving assembly driving the driven wheel to rotate via the driving wheel, thus giving a user a rotating prompt.

2. The portable electronic device as claimed in claim 1, wherein the driving wheel includes a stopping block, the driven wheel includes a connecting portion, the stopping block engages with the connecting portion, making the driven wheel rotate together with the driving wheel.

3. The portable electronic device as claimed in claim 2, wherein the stopping block includes a sliding surface and a stopping surface, the connecting portion includes a resisting arm with a resisting surface and a slope surface, the resisting surface abuts against the stopping surface, the sliding surface faces the slope surface.

4. The portable electronic device as claimed in claim 2, wherein the driving wheel includes a cam portion, the cam portion is a hollow column with a bottom wall and a peripheral wall, the stopping blocks are disposed on an interior surface of the peripheral wall.

5. The portable electronic device as claimed in claim 1, wherein the cover assembly includes a mounting portion, the mounting portion is a shoulder hole including a first bottom wall and a through hole through the cover assembly, the driven wheel includes a support portion and a base, the base resisting the bottom wall, the support portion exposes out of the through hole.

6. The portable electronic device as claimed in claim 5, wherein the support portion is a generally annular resisting wall with a support wall, the support wall defines a plurality of grooves to enlarge the friction force when the support portion is located on a surface.

7. The portable electronic device as claimed in claim 1, wherein the driving assembly includes a worm gear, the driving wheel includes a gear portion, the worm gear engages with the gear portion.

8. The portable electronic device as claimed in claim 7, wherein the driving wheel includes a pivoting pole protruding therefrom at a center, the driven wheel includes a hollow pivoting column protruding therefrom at a center, the pivoting pole is received in the pivoting column.

9. A portable electronic device with a rotating prompt of incoming calls comprising:
a rotating mechanism, the rotating mechanism including a rotating assembly and a driving assembly, the rotating assembly including a driving wheel and a driven wheel connected to the driving wheel, the driving wheel being connected to the rotating assembly, the driving assembly driving the driven wheel to rotate via the driving wheel, thus giving a user a rotating prompt.

10. The portable electronic device as claimed in claim 9, wherein the driving wheel includes a stopping block, the driven wheel includes a connecting portion, the stopping block engages with the connecting portion, making the driven wheel rotate together with the driving wheel.

11. The portable electronic device as claimed in claim 10, wherein the stopping block includes a sliding surface and a stopping surface, the connecting portion includes a resisting arm with a resisting surface and a slope surface, the resisting surface abuts against the stopping surface, the sliding surface faces the slope surface.

12. The portable electronic device as claimed in claim 10, wherein the driving wheel includes a cam portion, the cam portion is a hollow column with a bottom wall and a peripheral wall, the stopping blocks are disposed on an interior surface of the peripheral wall.

13. The portable electronic device as claimed in claim 9, wherein the driving assembly includes a worm gear, the driving wheel includes a gear portion, the worm gear engages with the gear portion.

14. The portable electronic device as claimed in claim 13, wherein the driving wheel includes a pivoting pole protruding therefrom at a center, the driven wheel includes a hollow pivoting column protruding therefrom at a center, the pivoting pole is received in the pivoting column.
